(19) United States
(12) Patent Application Publication
(10) Pub. No.: US 2005/0254673 A1
(43) Pub. Date: Nov. 17, 2005

(54) High performance MEMS thin-film teflon electret microphone

(75) Inventors: Wen Hsuan Hsieh, Pasadena, CA (US); Yu-Chong Tai, Pasadena, CA (US)

Correspondence Address: FOLEY AND LARDNER;SUITE 500, 3000 K STREET NW, WASHINGTON, DC, 20007, US

(73) Assignee: California Institute of Technology

(21) Appl. No.: 11/179,464

(22) Filed: Jul. 13, 2005

Related U.S. Application Data
(63) Continuation of application No. 09/574,448, filed on May 19, 2000.
(60) Provisional application No. 60/134,901, filed on May 19, 1999.

(51) Int. Cl. H04R 25/00

(52) U.S. Cl. 381/175; 381/191

(57) ABSTRACT

High performance MEMS thin film electret microphones, components and methods for making the same are disclosed. The microphones generally include a transducer diaphragm including an IC-compatible membrane support structure, a membrane layer formed on the membrane support structure, and a first electrode; a transducer back plate having a second electrode; and an electret layer formed on at least one of the transducer diaphragm or the transducer back plate. The transducer diaphragm and transducer back plate are fabricated using micromachining techniques and are generally compatible with microelectronics. The microphones generally have high open-circuit sensitivities, low noise levels, and low total harmonic distortion.

### CROSS REFERENCE TO RELATED APPLICATIONS

This application claims priority under 35 U.S.C. § 119(e) to Provisional Application Ser. No. 60/134,901, filed on May 19, 1999, which is incorporated by reference herein in its entirety.

### BACKGROUND

This invention relates to electret microphones and methods of manufacturing the same. An electret is a dielectric that produces a permanent external electric field that results from permanent ordering of molecular dipoles or from stable uncompensated surface or space charge. Electrets have been the subject of study for their charge storage characteristics as well as for their application in a wide variety of devices such as acoustic transducers, electrographic devices, air filters and photocopy machines.

Average performing commercial (non-MEMS) electret microphones have open-circuit sensitivities (S_{o.c.}) of 1-20 mV/Pa. Others have reported MEMS microphones with sensitivities ranging from 0.2-25 mV/Pa (P. R. Scheeper et al., Sensors and Actuators A 44, 1994, pp. 1-11). Some of these MEMS microphones require external biasing (D. Schafer et al., Hilton Head 1998, pp. 27-30), while others are electret-based (D. Hohm and R. Gerhard-Multhaupt, J. Acoustic Soc. Amer. 75(4), April 1984, pp. 1297-1298). However, there remains a need for small, inexpensive, high quality, high performance, self-powered electrets, particularly electret microphones.

### SUMMARY

In general, in one aspect, the invention provides a transducer diaphragm. The transducer diaphragm includes an IC-compatible support structure and a polymeric membrane layer formed on the support structure.

Particular implementations of the invention can include one or more of the following features. The polymeric membrane layer includes Mylar, FEP, a PTFE fluoropolymer, Teflon® AF, polyimide, a silicone, or Parylene. The polymeric membrane layer has a thickness in the range from about 0.1 μm to about 10 μm. The polymeric membrane layer is spun or deposited onto the support structure using micromachining techniques. The support structure is formed from an electrically insulating or semiconducting glass, ceramic, crystalline, or polycrystalline material. The polymeric membrane layer adheres to the support structure without requiring gluing. The transducer diaphragm includes an electret layer formed on the polymeric membrane layer by micro-machining techniques. The electret layer is thermally annealed to stabilize charge therein. The electret layer is heated to about 100° C. for about 3 hours for thermal annealing. The electret layer includes a charged dielectric film formed on the polymeric membrane layer. The dielectric film is charged by implanting electrons into the dielectric film by means of a thyratron. The dielectric film is formed from Mylar, FEP, a PTFE fluoropolymer, Teflon® AF, a silicone, or Parylene. The electret has a saturated charged density from about 2×10⁻⁵ C/m² to about 8×10⁻⁴ C/m².

In general, in another aspect, the invention provides a transducer back plate. The transducer back plate includes a support structure defining a back volume and a membrane layer formed on the support structure. The membrane layer has a front face and a rear face. The membrane layer includes a plurality of cavities extending from the front face to the rear face, thereby providing for communication between the front face and the back volume.

Particular implementations of the invention can include one or more of the following features. The transducer back plate includes a polymeric reinforcing film formed on the membrane layer and the plurality of cavities extend through the polymeric reinforcing film. The polymeric reinforcing film includes Mylar, FEP, a PTFE fluoropolymer, Teflon® AF, a silicone, or Parylene. The polymeric reinforcing film has a thickness in the range from about 0.1 μm to about 10 μm. The polymeric reinforcing film is spun or deposited onto the membrane layer using micromachining techniques. The support structure is formed from an electrically insulating or semiconducting glass, ceramic, crystalline, or polycrystalline material. The transducer back plate includes a spacer formed on the polymeric reinforcing film to define an air gap and the air gap communicates with the back volume through the plurality of cavities. The plurality of cavities includes an array of about 25,000 holes extending through the membrane layer. The membrane layer has a diameter of about 8 millimeters. The transducer back plate includes an electret layer formed on the membrane layer by micro-machining techniques.

In general, in another aspect, the invention provides an electret sound transducer. The sound transducer includes a transducer diaphragm including an IC-compatible membrane support structure and a polymeric membrane layer formed on the membrane support structure by micro-machining techniques and first electrode, a transducer back plate having a second electrode and formed by micro-machining techniques, and an electret layer formed on at least one of the transducer diaphragm or the transducer back plate. The transducer diaphragm is positioned adjacent to the transducer back plate to form an electret sound transducer.

Particular implementations of the invention can include one or more of the following features. The polymeric membrane layer includes one of Mylar, FEP, a PTFE fluoropolymer, Teflon® AF, polyimide, a silicone, or Parylene. The polymeric membrane layer has a thickness in the range from about 0.1 μm to about 10 μm. The polymeric membrane layer is spun or deposited onto the membrane support structure using micromachining techniques. The membrane support structure is formed from an electrically insulating or semiconducting glass, ceramic, crystalline, or polycrystalline material. The polymeric membrane layer adheres to the membrane support structure without requiring gluing. The transducer back plate includes a back plate support structure defining a back volume and a back plate membrane layer formed on the back plate support structure. The back plate membrane layer has a front face and a rear face. The back plate membrane layer includes a plurality of cavities extending from the front face to the rear face, thereby providing for communication between the front face and the back volume. The sound transducer includes a polymeric reinforcing film formed on the back plate membrane layer and the plurality of cavities extend through the polymeric reinforcing film. The polymeric reinforcing film includes one of Mylar, FEP, a PTFE fluoropolymer, Teflon® AF, a silicone, or Parylene. The polymeric reinforcing film has a thickness in the range from about 0.1 μm to about 10 μm. The polymeric reinforcing film is spun or deposited onto the back plate membrane layer using micromachining techniques. The back plate support structure is formed from an electrically insulating or semiconducting glass, ceramic, crystalline, or polycrystalline material. The sound transducer includes at least one spacer positioned between the transducer diaphragm and the transducer back plate to define an air gap and the air gap communicates with the back volume through the cavities. The plurality of cavities includes an array of about 25,000 holes extending through the back plate membrane layer. The membrane layer has a diameter of about 8 millimeters. The air gap is about 4.5 μm deep.

In general, in another aspect, the invention provides an electret sound transducer. The sound transducer includes a transducer diaphragm including a membrane support structure and a membrane layer formed on the membrane support structure by micro-machining techniques and a first electrode, a transducer back plate having a second electrode and formed by micro-machining techniques, and an electret layer formed on at least one of the transducer diaphragm or the transducer back plate. The transducer back plate includes a back plate support structure defining a back volume and a back plate membrane layer formed on the back plate support structure. The back plate membrane layer has a front face and a rear face. The back plate membrane layer includes a plurality of cavities extending from the front face to the rear face, thereby providing for communication between the front face and the back volume. The transducer diaphragm is positioned adjacent to the transducer back plate to form an electret sound transducer.

Particular implementations of the invention can include one or more of the following features. The sound transducer includes a polymeric reinforcing film formed on the back plate membrane layer and the cavities extend through the polymeric reinforcing film. The polymeric reinforcing film includes one of Mylar, FEP, a PTFE fluoropolymer, Teflon® AF, a silicone, or Parylene. The polymeric reinforcing film has a thickness in the range from about 0.1 μm to about 10 μm. The polymeric reinforcing film is spun or deposited onto the back plate membrane layer using micromachining techniques. The back plate support structure is formed from an electrically insulating or semiconducting glass, ceramic, crystalline, or polycrystalline material. The sound transducer includes at least one spacer positioned between the transducer diaphragm and the transducer back plate to define an air gap and the air gap communicates with the back volume through the plurality of cavities. The plurality of cavities includes an array of about 25,000 holes extending through the back plate membrane layer. The membrane layer has a diameter of about 8 millimeters. The air gap is about 4.5 μm deep. The transducer has an open circuit sensitivity greater than about 25 mV/Pa. The transducer has a noise level of less than about 30 dB SPL. The transducer has a total harmonic distortion of less than about 2% at 110 dB SPL at 650 Hz.

In general, in still another aspect, the invention provides an electret sound transducer. The sound transducer includes a transducer diaphragm including an IC-compatible membrane support structure and a membrane layer formed on the membrane support structure by micro-machining techniques and a first electrode, a transducer back plate having a second electrode and formed by micro-machining techniques, and an electret layer formed on at least one of the transducer diaphragm or the transducer back plate. The transducer diaphragm is positioned adjacent to the transducer back plate to form an electret sound transducer having an open-circuit sensitivity greater than about 25 mV/Pa, a noise level of less than about 30 dB SPL, and a total harmonic distortion of less than about 2% at 110 dB SPL at 650 Hz. In particularly advantageous implementations of the invention, the transducer has an open circuit sensitivity of greater than about 35 mV/Pa.

In general, in another aspect, the invention provides a method of fabricating a transducer diaphragm. The method includes providing an IC-compatible support structure; forming a polymeric membrane layer on the support structure; forming an electrode on the polymeric membrane layer; and etching a portion of the support structure to form a transducer diaphragm.

Particular implementations of the invention can include one or more of the following features. The polymeric membrane layer includes one of Mylar, FEP, a PTFE fluoropolymer, Teflon® AF, polyimide, a silicone, or Parylene. The polymeric membrane layer is spun on to a surface of the support structure. The polymeric membrane layer is deposited on a surface of the support structure. The polymeric membrane layer adheres to the support structure without requiring gluing. The polymeric membrane layer is formed at about room temperature. The polymeric membrane layer is formed to a thickness in the range from about 0.1 μm to about 10 μm. The support structure is formed from an electrically insulating or semiconducting glass, ceramic, crystalline, or polycrystalline material. Etching a portion of the support structure includes etching a silicon layer with bromine trifluoride. The method includes forming an electret layer on the polymeric membrane layer.

In general, in another aspect, the invention provides a method of fabricating a transducer back plate. The method includes providing a support structure having a front face and a back face; etching the back face of the support structure to form a support layer adjacent to an insulating layer; forming a plurality of cavities through the insulating layer; forming a polymeric reinforcing layer on the insulating layer; forming an electrode on the polymeric reinforcing layer; and etching the support layer to free a composite membrane. The front face is coated with the insulating layer. The cavities extend into the support layer. The cavities are in communication with a back volume formed in the support structure.

Particular implementations of the invention can include one or more of the following features. The polymeric reinforcing layer includes one of Mylar, FEP, a PTFE fluoropolymer, Teflon® AF, polyimide, a silicone, or Parylene. The polymeric reinforcing layer is formed at about room temperature. The polymeric reinforcing layer is formed to a thickness in the range from about 0.1 μm to about 10 μm. The support structure is formed from an electrically insulating or semiconducting glass, ceramic, crystalline, or polycrystalline material. The support layer is etched with bromine trifluoride. The method includes forming at least one spacer on the polymeric reinforcing layer to define an air gap. The plurality of cavities include an array of about 25,000 holes extending through the insulating layer. The insulating layer has a diameter of about 8 millimeters. The method includes forming an electret layer on the polymeric reinforcing layer.

Advantages that can be seen in implementations of the invention can include one or more of the following. Thin-film Teflon electret microphones of the invention have high open- circuit sensitivities, wide dynamic range, broad bandwidth, very low stray capacitance, and low harmonic distortion, are self-biasing, mass producible, arrayable, integrable with on-chip electronics, structurally simple and have been extremely stable in the ordinary environment.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a process flow diagram illustrating the fabrication of an electret diaphragm for an electret microphone according to the present invention.

FIG. 2 is a process flow diagram illustrating the fabrication of a microphone back plate for an electret microphone according to the present invention.

FIG. 3 is a close-up view of the diaphragm chip and back plate chip of FIGS. 1 and 2, respectively.

FIG. 4 is a cross-sectional view of an assembled electret microphone fabricated according to FIGS. 1 and 2.

FIG. 5 is a schematic representation of an electret microphone-preamplifier test circuit.

FIG. 6 is a process flow diagram illustrating the fabrication of an electret diaphragm for an electret microphone according to another implementation of the present invention.

FIG. 7 is a cross-sectional view of an assembled electret microphone fabricated according to FIG. 8.

Like reference symbols in the various drawings indicate like elements.

### DETAILED DESCRIPTION

Miniature (e.g., millimeter scale) electret sound transducers (microphones) are manufactured as two-piece units including a transducer diaphragm and a transducer back plate. The transducers are manufactured using micromachining techniques, employing substrates that can accommodate microelectronics (i.e., substrates that are compatible with integrated circuits) and processes and equipment commonly used in the microelectronics industry. When juxtaposed, the two units form a microphone that can produce a signal without the need for external biasing. These electret microphones have open-circuit sensitivities of about 45 mV/Pa, equivalent to the best Brüel & Kjaer (B&K) ½-inch reference electret microphones, and generally have very low stray capacitance, are self-biasing, mass producible, arrayable, integrable with on-chip electronics, structurally simple and have been extremely stable over a one-year period (to-date) in the ordinary environment. Their dynamic range is generally from less than about 30 dB to above about 110 dB SPL (re. 20 μPa), their bandwidth is generally greater than 10 kHz, their open-circuit sensitivity generally ranges from about 0.2 mV/Pa to about 45 mV/Pa from 100 Hz to 10 kHz, and their total harmonic distortion is generally about 1% at 110 dB SPL, 650 Hz.

To demonstrate the self-powering capability of a MEMS compatible electret device, two types of MEMS electret microphones were fabricated and tested. Microphone A includes a diaphragm having a silicon nitride/Teflon AF composite membrane, while microphone B includes a diaphragm having a Parylene C/Teflon AF composite membrane. Both microphones use the same perforated silicon nitride/Parylene C backplate.

Electret Microphone A

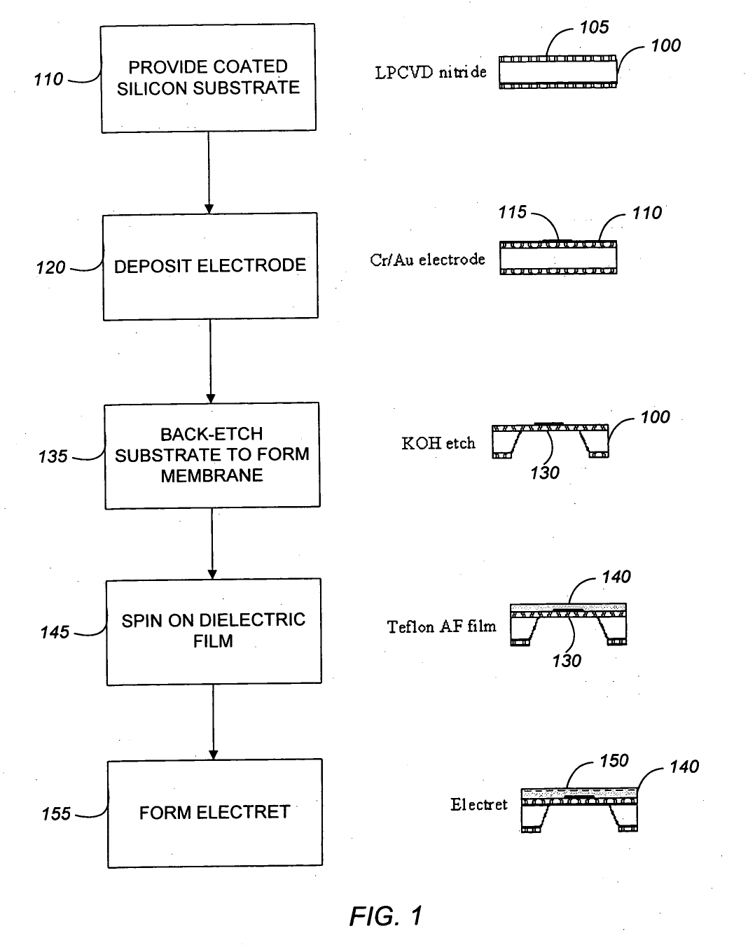

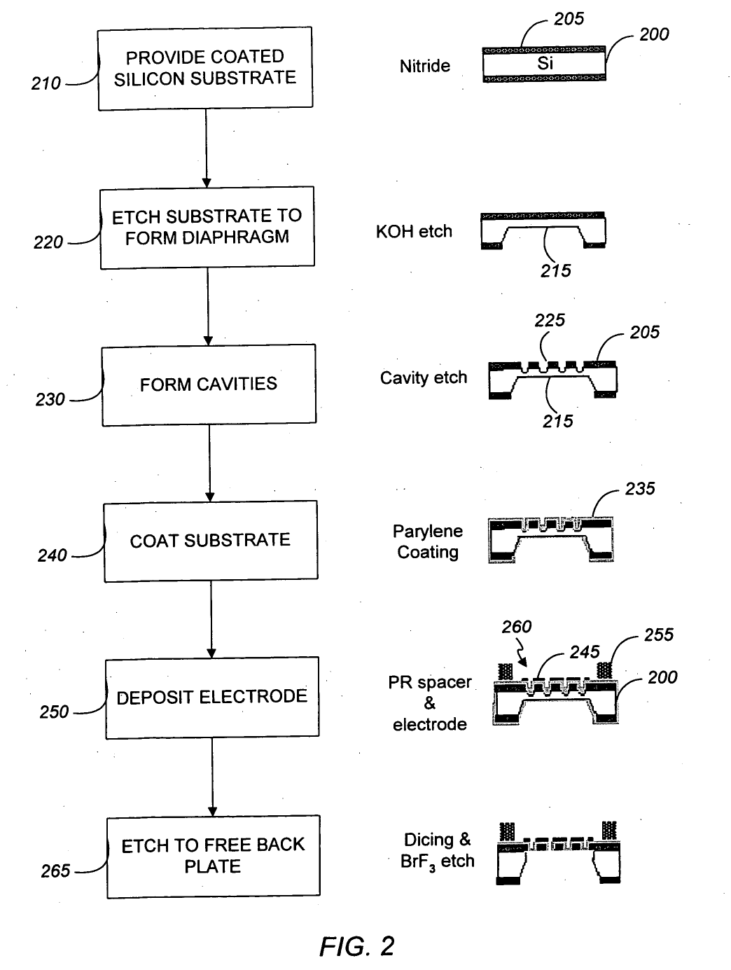

The fabrication of one embodiment of an electret microphone is illustrated in FIGS. 1 and 2. As shown in FIG. 1, diaphragm fabrication begins with a <100> silicon substrate 100 coated with 0.5 μm low-stress low pressure chemical vapor deposition (LPCVD) silicon nitride layer 105 (SiH₂Cl₂/NH₃=4.3 at 837° C.) (step 110). Other substrate materials (which can be etched in many known ways) such as glass, quartz or sapphire can be used with other membrane layers such as silicon dioxide.

An electrode 115 is deposited on the front side of layer 105, preferably by evaporation of about 1000 Å Cr/Au (step 120). After patterning with photoresist, this layer of metal forms one of the microphone electrodes. Other conductors can be used, including, for example aluminum or copper, deposited by known methods such as evaporation or sputtering.

The nitride on the backside of substrate 100 is masked with photoresist, patterned and etched (e.g., with SF₆ plasma) in conventional fashion to form a back-etch window. Substrate 100 is anisotropically back-etched to form a free-standing nitride membrane 130 (approximately 8 mm×8 mm in the embodiment shown) (step 135). The anisotropic etchant can be, for example, potassium hydroxide (KOH), ethylene diamine pyrocatecol (EDP) or tetramethyl ammonium hydroxide (TMAH).

A dielectric film 140 is spun over the front surface of membrane 130 to a thickness of about 1 μm (step 145). Other thicknesses of the film, such as from 0.1 μm to 10 μm can also be used. Film 140 preferably includes Teflon® AF 1601S, an amorphous fluoropolymer available from Du Pont. This material was chosen because it is available in liquid form at room temperature, thus making it suitable for spin-on applications. It can form extremely thin films (down to sub-micron thickness), has good charge storage characteristics, good chemical resistance, low water absorption and high temperature stability. For time spans longer than usual processing times, the adhesion of the Teflon film to different material surfaces such as silicon, silicon dioxide, silicon nitride, copper, gold, and chrome is satisfactory in the presence of chemicals frequently used in MEMS fabrication, such as water, photoresist developers, acetone, alcohol, HF and BHF. Film 140 can also be patterned/etched with oxygen plasma using a physical or photoresist mask. However, other dielectric materials such as Mylar, PTFE, FEP, silicones or Parylene may also be used. In the illustrated embodiment, film 140 was spun over membrane 130 to a thickness of 0.9 μm and baked at about 250° C. for about 3 hours to drive off the Fluoroinert® FC-75 solvent.

An electret 150 is formed by implanting electrons of about 7-10 keV energy into film 140 (step 155), preferably using a Back-Lighted Thyratron (BLT) as described in co-pending U.S. patent application Ser. No. 08/844,570, filed on Apr. 18, 1997, which is incorporated by reference herein. Using this method, Teflon electret samples with charge densities from 1×10⁻⁵ C/m² to 8×10⁻⁴ C/m² have been obtained (as measured by a Monroe Electronics Model 1017 Voltmeter Probe Type AEH). Over a period of two and a half years no measurable charge decay has been observed for stabilized electrets at room temperature. These samples were observed to lose 80% of their charge at 190° C. Other electron implantation methods can also be used, such as a scanning electron beam, corona charging, liquid contact, or thermal charging. In one implementation, use of the BLT is preferred because it operates at room temperature, the electron beam energy can be easily varied from 5-30 keV, it has a large beam size (several millimeters in diameter), it can deliver high electron doses (10⁻⁹−10⁻⁶ C), it has high throughput and is low cost.

The electret is then stabilized—for example, by baking at 100° C. in air for 3 hours. In the embodiment of FIG. 1, a charge density on the order of 10⁻⁴ C/m² was obtained.

Referring to FIG. 2, the back plate of the microphone is fabricated from a <100> silicon substrate 200 coated with 1.1 μm thick low stress LPCVD silicon nitride insulating layer 205 (SiH₂Cl₂/NH_{3=4.3} at 837° C.) (step 210). Other substrate materials (which can be etched in many known ways) such as glass, quartz or sapphire can be used with other membrane layers such as silicon dioxide.

Substrate 200 is anisotropically bulk etched, until a silicon membrane 215 approximately 20 μm thick remains (step 220). The anisotropic etchant can include, for example, potassium hydroxide (KOH), ethylene diamine pyrocatecol (EDP) or tetramethyl ammonium hydroxide (TMAH). The nitride layer 205 is patterned (e.g., by SF₆ plasma etching) to form an array of cavities 225 (step 230). In the illustrated embodiment, array 225 is a 160×160 array of holes etched approximately 5 μm deep through the 1.1 μm thick nitride 205 and into silicon membrane 215. Each hole has a diameter of about 30 μm and the holes are spaced about 50 μm apart (center-to-center). These holes increase the upper cut-off frequency of the microphone by providing for communication between the air gap and a back volume space formed in substrate 200 to reduce the squeeze-film damping effects in the air gap. The number and size of the cavities can vary, towards the end of minimizing the squeeze-film damping effects by, e.g., maximizing the number of holes and minimizing their size.

A coating 235 (e.g., approximately 2.4 μm of Parylene C) is deposited over both sides of substrate 200 to provide structural reinforcement for the back plate nitride membrane (step 240). Other polymeric material, such as other Parylenes, polyimide, Mylar or other carbon-fluorine based polymers, or combinations of such materials, can be used in place of Parylene C to provide structural reinforcement. Parylene C is particularly preferred because of its good adhesion characteristics, its ability to be deposited uniformly at room temperature from the vapor phase, the good control over its thickness, its ability to be etched (by e.g., oxygen plasma), its good mechanical properties and because it is inert to other common reagents used in micromachining fabrication processes.

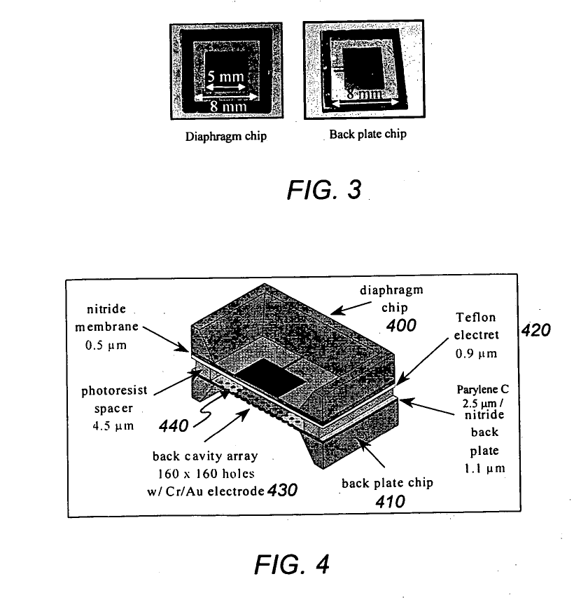

A back plate electrode 245 is deposited, preferably by thermal evaporation of an approximately 1000 Å thick layer of Cr/Au, and patterned on top of the front-side Parylene coating (step 250). Other conductors can be used for electrode 245, such as evaporated or sputtered aluminum or copper. Spacers 255 (e.g., 4.5 μm thick hard-baked photoresist) are then applied to the front side of substrate 200 to define an air gap 260 between the electrodes. The static pressure equalization hole extends across the entire back plate chip and is defined by the 4.5 μm×8.3 mm cross-sectional area between the spacers. This static pressure equalization hole governs the low frequency cutoff of the assembled microphone and can be designed to encompass different cross-sectional areas. Finally, coating 235 is etched away in the back cavity (e.g., with oxygen plasma) to expose silicon membrane 215, which is etched (e.g., with BrF₃) to free the perforated nitride/Parylene C composite backplate (step 265). The Parylene C stubs protruding from the 160×160 array of holes are removed—for example, by oxygen plasma etching—from the backside of the wafer. The completed microphone diaphragm and back plate are shown in FIG. 3.

A schematic cross-section of the assembled microphone is illustrated in FIG. 4. The microphone diaphragm 400 and back plate 410 are shown juxtaposed such that the electret 420 is positioned approximately parallel to but spaced apart from the back plate electrode 430 by a gap 440. The microphone diaphragm 400 and back plate 410 can be mechanically clamped together, or can be bonded adhesively, chemically or thermally. If desired, the completed microphone can be enclosed in a conductive structure to provide electromagnetic shielding. If the microphone diaphragm 400 and backplate 410 are hermetically sealed in a vacuum chamber, then the cavities for reducing the air streaming resistance and the steps for their formation can be omitted. While electret 420 is shown as being formed on diaphragm 400, similar processing techniques can be used to form electret 420 on the facing surface of back plate 410 or on both diaphragm 400 and back plate 410.

To reduce the stray capacitance, the total electrode area covers only a fraction of the area of the microphone diaphragm 400 and back plate 410. In the illustrated embodiment, 5 mm×5 mm electrodes were used to cover the center portion of 8 mm×8 mm diaphragm 400 and back plate 410.

Using a laser Doppler vibrometer, the resonant frequency of the free-standing composite nitride diaphragm (with 1000 Å Cr/Au and 0.9 μm Teflon electret) was determined to be approximately 17 kHz. This does not differ significantly from the calculated theoretical fundamental resonant frequency, f₁₁=(σₙ/2a²ρ)^{0.5}, of 19.4 kHz for an identically sized plain square nitride membrane with large tensile stress (P. Morse & K. U. Ingard, Theoretical Acoustics, McGraw-Hill, New York, 1st edn., pp. 383-394 and 474-490, 1968); where: tensile residual stress (σₙ)=150 MPa, nitride density (ρ)=3100 kg/M³ and length of one side of the square membrane (a)=8 mm. The measured resonant frequency is lower than theoretical due to the increased effective mass of the membrane caused by the Cr/Au electrode and Teflon electret.

For a 4.5 μm air gap, a 0.9 μm thick Teflon electret, a back plate with a hole opening ratio of 0.3 and an electrode area of 25 mm², the theoretical capacitance of the microphone is about 31 pF. The measured capacitance was 25 pF. The small discrepancy between the theoretical and experimental values can probably be attributed to the fact that the top and bottom Cr/Au electrodes of the microphone do not perfectly overlap.

Electret microphone A was tested in a Brüel & Kjaer (B&K) Type 4232 anechoic test chamber. An integrated speaker in the test chamber served as the acoustic source. A B&K Type 4189 ½-inch reference microphone was used to measure the sound pressure level at the test position. The reference microphone was connected to a B&K Type 2669 preamplifier and a B&K Type 5935 dual channel amplifier/power supply. The electret microphone under test was also connected to a B&K Type 2669 preamplifier and it shared the same B&K dual channel amplifier/power supply with the reference microphone. This ensured that the only variable in the entire test system was the MEMS electret microphone and that the other components were kept constant.

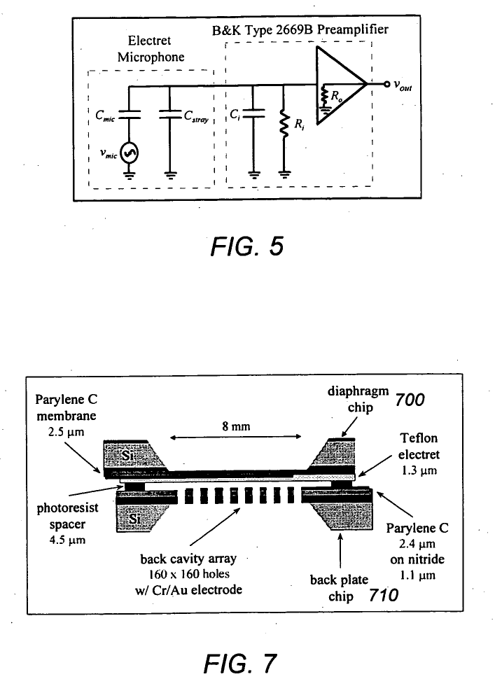

The schematic representation of the electret microphone-preamplifier circuit is shown in FIG. 5. The electrical response of the circuit is given by:

$${H}_{e} ( ω ) = {v}_{out} / {v}_{mic} = j ω {R}_{i} {C}_{mic} / [ 1 + jω {R}_{i} ( {C}_{stray} + {C}_{mic} + {C}_{i} ) ]$$

where ω is the frequency in rad/s. For an electret microphone capacitance (C_{mic})=25 pF, package stray capacitance (C_{stray})=2 pF, preamplifier input capacitance (Cᵢ)=0.45 pF, preamplifier input resistance (Rᵢ)=15 GΩ and preamplifier output resistance (Rₒ)=25 Ω, Hₑ(ω) is a constant and equal to 0.91 over the frequency range of interest (100 Hz-10 kHz). The low-frequency roll-off is less than 50 Hz, and the high frequency roll-off is much greater than 20 kHz. Thus, the electrical response is well suited for acoustic signals in the audible range.

Using a Stanford Research Systems Model SR785 Dynamic Signal Analyzer to apply an input sinusoidal signal of known sound pressure level from 100 Hz to 10 kHz, the overall electromechanical frequency response of electret microphone A was obtained. Sound pressure levels with lower and higher frequencies were not used because the built-in speaker of the anechoic sound chamber is severely attenuated below 100 Hz and above 10 kHz. The measured open circuit sensitivity of microphone A was found to be approximately 45 mV/Pa from 150 Hz to 3 kHz and the bandwidth of the microphone is greater than 10 kHz.

For membrane deflections smaller than the membrane thickness and assuming a plain square nitride membrane with large initial stress, the first order calculation of the theoretical microphone open-circuit sensitivity (S_{o.c.}) is given by:

$${S}_{o . c .} = [ \frac{{s}_{e} {σ}_{e}}{{ɛ}_{0} ( {s}_{e} + {ɛ}_{e} {s}_{a} )} ] [ \frac{{a}^{2}}{2 Ct {σ}_{n}} ] [ R ] = 50 mV \text{/} Pa$$

(P. R. Scheeper et al., Sensors and Actuators A 44, 1994, pp. 1-11) where: electret thickness (sₑ)=0.9 μm, electret surface charge density (σₑ)=1.2×10⁻⁴ C/m², air gap thickness (sₐ)=4.5 μm, permitivity of free space (δₑ)=8.85×10⁻¹² F/m, relative permitivity of the Teflon electret (εₑ)=1.9, length of one side of the square membrane (a)=8 mm, C=3.04, nitride membrane thickness (t)=0.5 μm, stress in the nitride membrane (σₙ)=150 MPa and ratio of Cr/Au electrode area to the total membrane area (R)=0.273. Because this equation ignores squeeze-film damping effects in the air gap, ignores the compliance of the perforated nitride back plate membrane, ignores the effects of the Cr/Au electrode and Teflon film on the mechanical sensitivity and assumes the ideal condition that all the electret charge resides at the surface of the electret-air interface, it is expected that the theoretical open-circuit sensitivity will be an over-estimate of the measured open-circuit sensitivity (especially at high frequencies).

The measured noise level of the MEMS electret microphone A (with B&K Type 2669 preamplifier) is less than 30 dB SPL at 20° C. In comparison, a B&K Type 4189 ½-inch electret microphone with the same preamplifier and at the same temperature has a noise level of 17 dB SPL. Since the noise pressure produced by an acoustic damping resistance is proportional to the square root of the acoustic resistance (Brüel & Kjaer, Microphone Handbook, Vol. 1, pp. 2-36/38, 1996), the higher noise floor of electret microphone A is not surprising, given its higher acoustic resistance due to larger air-film damping.

The open circuit distortion limit of electret microphone A was found to be above 110 dB SPL (the maximum output of the anechoic sound chamber speaker). This test was conducted at 650 Hz and the measured Total Harmonic Distortion of the electret microphone was less than 1%. Given that the lowest detectable sound pressure level is 30 dB SPL, this translates into a microphone dynamic range that is greater than 80 dB SPL. Those skilled in the art will recognize that potentially higher sensitivities, lower noise levels and wider dynamic ranges are achievable using these techniques.

Electret Microphone B

Microphone B uses the same perforated silicon nitride/Parylene C backplate as microphone A, but uses a composite membrane formed from polymeric material (Parylene C/Teflon AF in the illustrated embodiment) instead of a silicon nitride-based membrane. The use of polymeric material in the diaphragm provides higher mechanical sensitivity (and therefore higher open-circuit sensitivity), better stress control, and permits the integration of the microphone with microelectronics that would be incompatible with the high deposition temperatures required for more conventional materials such as silicon nitride. Parylene is particularly preferred because of its good adhesion characteristics, its ability to be deposited uniformly at room temperature from the vapor phase, the good control over its thickness, its ability to be etched (by e.g., oxygen plasma), its good mechanical properties and because it is inert to other common reagents used in micromachining fabrication processes.

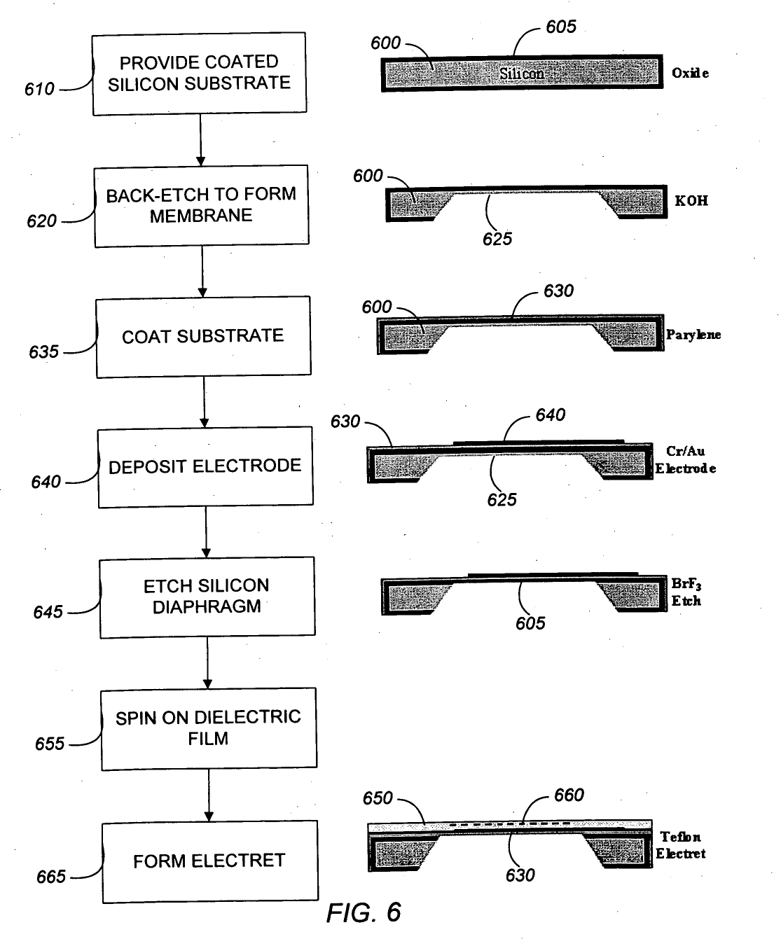

The fabrication of electret microphone B is illustrated in FIG. 6. Diaphragm fabrication begins with a <100> silicon substrate 600 coated with a layer 605 of thermal silicon dioxide (approximately 2 μm) (step 610). Other substrate materials (which can be etched in many known ways) such as glass, quartz or sapphire can be used with other membrane layers such as silicon nitride.

The oxide layer on the backside of substrate 600 is masked with photoresist, patterned and etched in the conventional fashion (e.g., with BHF) to form a back-etch window. A timed anisotropic back-etch follows (step 620), leaving a silicon membrane 625 approximately 20 μm thick. The anisotropic etchant can be, for example, potassium hydroxide (KOH), ethylene diamine pyrocatecol (EDP) or tetramethyl ammonium hydroxide (TMAH).

A coating 630 (e.g., approximately 2.5 μm Parylene C) is deposited on the front side of substrate 600 (step 635). Coating 630 can be deposited in thicknesses ranging from 0.1 μm to over 10 μm. Other polymeric materials can be used in place of Parylene C, such as other Parylenes, polyimide, Mylar or other carbon-fluorine based polymers, or combinations of such materials. Those skilled in the art will select an appropriate material based on characteristics such as deposition rate and post-annealing temperature. An electrode 640 is deposited on the front side of coating 630, preferably by evaporation of about 2000 Å Cr/Au (step 640). After patterning with photoresist, this layer of metal forms one of the microphone electrodes. Other conductors can be used, including, for example aluminum or copper, deposited by known methods such as evaporation or sputtering. After patterning with photoresist, this layer of metal forms one of the microphone electrodes.

The remaining silicon membrane 625 is etched away (e.g., using BrF₃), as is the remaining silicon dioxide 605 (in a one-sided BHF etch) leaving only the 2.5 μm Parylene C membrane 630 (step 645). A dielectric film 650 is spun over the front surface of membrane 630 (step 655). As discussed above, preferably film 650 includes Teflon AF. In this embodiment, film 650 was spun over membrane 630 to a thickness of 1.3 μm and baked at 115° C. for 45 minutes and then at 170° C. for 15 minutes to drive off the Fluoroinert® FC-75 solvent.

An electret 660 is formed by implanting electrons of about 7-10 keV energy into film 650, preferably using a Back-Lighted Thyratron (BLT) as discussed above (step 665). Electret 660 is stabilized—for example, by baking at 100° C. in air for 3 hours. For the embodiment of FIG. 6, a charge density on the order of 10⁻⁵ C/m² was obtained.

A schematic cross-section of the assembled microphone B is illustrated in FIG. 7. As shown, the cross-section of microphone B is similar to that of microphone A except that the diaphragm chip of microphone B is made of a Parylene C/Teflon AF composite instead of a silicon nitride/Teflon AF composite. The microphone diaphragm 700 and back plate 710 can be mechanically clamped together, or can be bonded adhesively, chemically or thermally. If desired, the completed microphone can be enclosed in a conductive structure to provide electromagnetic shielding. If the microphone diaphragm 700 and backplate 710 are hermetically sealed in a vacuum chamber, then the cavities for reducing the air streaming resistance and the steps for their formation can be omitted. As described above, the electret can be formed on diaphragm 700, on the facing surface of back plate 710 or on both diaphragm 700 and back plate 710.

As in microphone A, to reduce the stray capacitance, the total electrode area covers only a fraction of the area of the microphone diaphragm 700 and back plate 710. In the illustrated embodiment, 5 mm×5 mm electrodes were used to cover the center portion of 8 mm×8 mm diaphragm 700 and back plate 710.

Using a laser Doppler vibrometer, the resonant frequency of the free-standing Parylene C/Teflon AF composite diaphragm (with 2100 Å Cr/Au) was determined to be approximately 14 kHz. The measured capacitance of the microphone was 8 pF.

Electret microphone B was tested in the same setup as described for electret microphone A. Using a Stanford Research Systems Model SR785 Dynamic Signal Analyzer to apply an input signal of known sound pressure level (SPL) from 100 Hz to 10 kHz, the frequency response of microphone B was obtained. The measured open circuit sensitivity of microphone B was found to be approximately 0.2-2 mV/Pa from 100 Hz to 10 kHz.

The measured noise level of electret microphone B (with B&K Type 2669 preamplifier) is less than 30 dB SPL at 20° C. The open circuit distortion limit of the electret microphone was found to be above 110 dB SPL (the maximum output of the anechoic sound chamber speaker). This test was conducted at 650 Hz and the measured Total Harmonic Distortion of the electret microphone was 1.79%. Given that the lowest detectable sound pressure level is 30 dB SPL, this translates into a microphone dynamic range that is greater than 80 dB SPL. The performance characteristics of microphone B are comparable to other microphones of similar size and preliminary calculations suggest that potentially higher sensitivities, lower noise levels and wider dynamic range are achievable.

The disclosed MEMS electret microphones can be used in any application where a conventional electret microphone can be used. In addition, because of their extremely small size and self-powering characteristics, the microphones can contribute to further miniaturization of portable telecommunication devices, hearing aids, etc. Moreover, the microphones can be used as powered sound transducers, allowing one or more of the units to be used, for example, in a hearing aid as a speaker. If multiple microphones are used, the frequency response of each can be tuned to desired values by changing the stiffness of the membrane (e.g. by changing its thickness) or by changing the area of the membrane.

Since the MEMS processes used in fabricating these microphones are compatible with the fabrication of integrated circuitry, such devices as amplifiers, signal processors, filters, A/D converters, etc. can be fabricated inexpensively as an integral part of the microphone unit. The low cost of manufacture and the ability to make multiple microphones on a substrate wafer permits use of multiple microphones in one unit, for redundancy or to provide directional sound perception.

A number of embodiments of the present invention have been described. Nevertheless, it will be understood that various modifications can be made without departing from the spirit and scope of the invention. For example, other etchants, metals, mask and substrate materials, lithographic methods, etching techniques, etc., can be used in place of specific materials and methods described above. Other dimensions for thicknesses, sizes, etc., can also be used to achieve the desired performance or fabrication parameters. While square microphones are shown, other shapes, such as circular or ellipsoid can also be fabricated. Further, some specific steps may be performed in different order to achieve similar structure. Accordingly, it is to be understood that the invention is not to be limited by the specific illustrated embodiment, but only by the scope of the appended claims.

1-23. (canceled)

24. An electret sound transducer, comprising:
a transducer diaphragm including an IC-compatible membrane support structure and a polymeric membrane layer formed on the membrane support structure by micro-machining techniques, the transducer diaphragm having a first electrode;
a transducer back plate having a second electrode and formed by micro-machining techniques; and
an electret layer formed on at least one of the transducer diaphragm or the transducer back plate, the transducer diaphragm being positioned adjacent to the transducer back plate to form an electret sound transducer.

25. The electret sound transducer of claim 24, wherein:
the polymeric membrane layer includes one of Mylar, FEP, a PTFE fluoropolymer, Teflon® AF, polyimide, a silicone, or Parylene.

26. The electret sound transducer of claim 25, wherein:
the polymeric membrane layer has a thickness in the range from about 0.1 μm to about 10 μm.

27. The electret sound transducer of claim 24, wherein:
the polymeric membrane layer is spun or deposited onto the membrane support structure using micromachining techniques.

28. The electret sound transducer of claim 24, wherein:
the membrane support structure is formed from an electrically insulating or semiconducting glass, ceramic, crystalline, or polycrystalline material.

29. The electret sound transducer of claim 24, wherein:
the polymeric membrane layer adheres to the membrane support structure without requiring gluing.

30. The electret sound transducer of claim 24, wherein:
the transducer back plate comprises a back plate support structure defining a back volume and a back plate membrane layer formed on the back plate support structure, the back plate membrane layer having a front face and a rear face, the back plate membrane layer comprising a plurality of cavities extending from the front face to the rear face, thereby providing for communication between the front face and the back volume.

31. The electret sound transducer of claim 30, further comprising:
a polymeric reinforcing film formed on the back plate membrane layer, the plurality of cavities extending through the polymeric reinforcing film.

32. The electret sound transducer of claim 31, wherein:
the polymeric reinforcing film includes one of Mylar, FEP, a PTFE fluoropolymer, Teflon® AF, a silicone, or Parylene.

33. The electret sound transducer of claim 32, wherein:
the polymeric reinforcing film is about 2.5 μm thick.

34. The electret sound transducer of claim 31, wherein;
the polymeric reinforcing film is spun or deposited onto the back plate membrane layer using micromachining techniques.

35. The electret sound transducer of claim 30, wherein:
the back plate support structure is formed from an electrically insulating or semiconducting glass, ceramic, crystalline, or polycrystalline material.

36. The electret sound transducer of claim 31, further comprising:
at least one spacer positioned between the transducer diaphragm and the transducer back plate to define an air gap, the air gap communicating with the back volume through the plurality of cavities.

37. The electret sound transducer of claim 36, wherein:
the plurality of cavities comprises an array of about 25,000 holes extending through the back plate membrane layer.

38. The electret sound transducer of claim 37, wherein:
the membrane layer has a diameter of about 8 millimeters.

39. The electret sound transducer of claim 38, wherein:
the air gap is about 4.5 μm deep.

40. An electret sound transducer, comprising:
a transducer diaphragm including a membrane support structure and a membrane layer formed on the membrane support structure by micro-machining techniques, the transducer diaphragm having a first electrode;
a transducer back plate having a second electrode and formed by micro-machining techniques, the transducer back plate comprising a back plate support structure defining a back volume and a back plate membrane layer formed on the back plate support structure, the back plate membrane layer having a front face and a rear face, the back plate membrane layer comprising a plurality of cavities extending from the front face to the rear face, thereby providing for communication between the front face and the back volume; and
an electret layer formed on at least one of the transducer diaphragm or the transducer back plate, the transducer diaphragm being positioned adjacent to the transducer back plate to form an electret sound transducer.

41. The electret sound transducer of claim 40, further comprising:
a polymeric reinforcing film formed on the back plate membrane layer, the plurality of cavities extending through the polymeric reinforcing film.

42. The electret sound transducer of claim 41, wherein:
the polymeric reinforcing film includes one of Mylar, FEP, a PTFE fluoropolymer, Teflon® AF, a silicone, or Parylene.

43. The electret sound transducer of claim 42, wherein:
the polymeric reinforcing film has a thickness in the range from about 0.1 μm to about 10 μm.

44. The electret sound transducer of claim 41, wherein:
the polymeric reinforcing film is spun or deposited onto the back plate membrane layer using micromachining techniques.

45. The electret sound transducer of claim 40, wherein:
the back plate support structure is formed from an electrically insulating or semiconducting glass, ceramic, crystalline, or polycrystalline material.

46. The electret sound transducer of claim 41, further comprising:
at least one spacer positioned between the transducer diaphragm and the transducer back plate to define an air gap, the air gap communicating with the back volume through the plurality of cavities.

47. The electret sound transducer of claim 46, wherein:
the plurality of cavities comprises an array of about 25,000 holes extending through the back plate membrane layer.

48. The transducer back plate of claim 47, wherein:
the membrane layer has a diameter of about 8 millimeters.

49. The electret sound transducer of claim 48, wherein:
the air gap is about 4.5 μm deep.

50. The electret sound transducer of claim 40, wherein:
the transducer has an open circuit sensitivity greater than about 25 mV/Pa.

51. The electret sound transducer of claim 50, wherein:
the transducer has a noise level of less than about 30 dB SPL.

52. The electret sound transducer of claim 52, wherein:
the transducer has a total harmonic distortion of less than about 2% at 110 dB SPL at 650 Hz.

53. An electret sound transducer, comprising:
a transducer diaphragm including an IC-compatible membrane support structure and a membrane layer formed on the membrane support structure by micro-machining techniques, the transducer diaphragm having a first electrode;
a transducer back plate having a second electrode and formed by micro-machining techniques; and
an electret layer formed on at least one of the transducer diaphragm or the transducer back plate, the transducer diaphragm being positioned adjacent to the transducer back plate to form an electret sound transducer having an open-circuit sensitivity greater than about 25 mV/Pa, a noise level of less than about 30 dB SPL, and a total harmonic distortion of less than about 2% at 110 dB SPL at 650 Hz.

54. The electret sound transducer of claim 53, wherein:
the transducer has an open circuit sensitivity of greater than about 35 mV/Pa.

55-74. (canceled)
